(19) United States
(12) Patent Application Publication
(10) Pub. No.: US 2013/0061787 A1
(43) Pub. Date: Mar. 14, 2013

(54) BIOMASS PULVERIZING APPARATUS AND BIOMASS/COAL MIXED-COMBUSTION SYSTEM

(71) Applicants: Yutaka Iida, Minato-ku (JP); Tsugio Yamamoto, Minato-ku (JP); Yoshiki Yamaguchi, Minato-ku (JP); Masaaki Kinoshita, Minato-ku (JP); Yoshishige Uematsu, Nagasaki-shi (JP)

(72) Inventors: Yutaka Iida, Minato-ku (JP); Tsugio Yamamoto, Minato-ku (JP); Yoshiki Yamaguchi, Minato-ku (JP); Masaaki Kinoshita, Minato-ku (JP); Yoshishige Uematsu, Nagasaki-shi (JP)

(21) Appl. No.: 13/698,777

(22) PCT Filed: May 16, 2011
(86) PCT No.: PCT/JP2011/061228

§ 371 Date: Nov. 19, 2012

(30) Foreign Application Priority Data
May 21, 2010 (JP) 2010-117650

(51) Int. Cl. B02C 15/00; F23K 1/00

(52) U.S. Cl. 110/232; 241/57

(57) ABSTRACT

A biomass pulverizing apparatus includes a pulverizing apparatus body having a feedstock supply pipe, a pulverizing table for placing the supplied biomass feedstock thereon, a drive section for rotationally driving the pulverizing table, a pulverizing roller for pulverizing the biomass feedstock by a pressing force, and a blower unit for forming an upward flow upward from below on the outer peripheral side of the pulverizing table so as to jet conveying gas, and the pulverizing apparatus further includes an erected weir that is provided around the pulverizing table, and a first extending weir that extends from the pulverizing apparatus body side at lower portions of the pulverizing rollers and is formed with a plurality of slits that forms a predetermined gap with the upper surface of the erected weir.

### FIELD

The present invention relates to a biomass pulverizing apparatus and a biomass/coal mixed-combustion system that crush and pulverize biomass solid matter.

### BACKGROUND ART

In recent years, reduction of CO₂ emissions has been promoted from a viewpoint of global warming. Particularly, in combustion facilities, such as boilers for power generation, fossil fuels, such as coal and heavy fuel oil, are used as fuel in many cases. However, this fossil fuel causes global warming from the problems of CO₂ emission, and the use thereof is being regulated from the standpoint of earth environmental preservation. Further, development and practical use of energy resources that substitute for this are required also from a viewpoint of exhaustion of fossil fuels. Therefore, utilization of fuel using biomass is promoted as an alternative to fossil fuels. The biomass is organic matter resulting from photosynthesis, and there is biomass, such as woody material, plants, agricultural products, and kitchen waste. By processing this biomass as fuel, the biomass can be effectively used as an energy source or an industrial source.

Using the biomass as fuel is performed from a viewpoint of efficient utilization of the biomass that is renewable energy. As one of the methods of using the biomass as fuel, there is a method of pulverizing solid biomass matter and supplying the pulverized matter to a pulverized coal burning boiler for use as fuel. In this method, an independent pulverization type that pulverizes coal and the biomass independently, and a mixed pulverization type that performs pulverization after coal and the biomass are mixed are known. In both types, a biomass pulverizing apparatus for pulverizing solid biomass matter is required. However, in a case of attempting to use an existing mill used with the coal burning boiler of the related art, a mixed combustion rate with respect to both remains at about 3 cal % at maximum from the capability constraints of the existing mill.

In order to pulverize the biomass of the related art to a particle diameter for the coal burning boiler, a coal pulverizer is used as it is, for example, biomass feedstock is input into a pulverizing table within a pulverizing apparatus, and is pulverized, dried, and classified by pulverizing rollers that rotate in conjunction with the pulverizing table. Then, the pulverized biomass is conveyed to the burner side in an air stream (refer to Patent Documents 1 and 2).

### CITATION LIST

### Patent Literature

Patent Literature 1: Japanese Laid-open Patent Publication No. 2004-347241
Patent Literature 2: Japanese Laid-open Patent Publication No. 2009-291692

### SUMMARY

### Technical Problem

However, in a case where woody biomass feedstock is pulverized using the coal pulverizing apparatus of the related art, there are the following problems.

1) Since the woody biomass feedstock has compressibility unlike coal, there is a problem in that pressure is not sufficiently transmitted to the biomass feedstock and pulverization is difficult in a case where the feedstock is bitten into the pulverizing rollers and the pulverizing table and is pulverized.

Further, since the biomass feedstock has high moisture content, and is fibrous, in a case where the feedstock is sandwiched between the pulverizing rollers and the pulverizing table and is pressed, the pulverized biomass powder (fine powder) is entangled with each other, and has a property of being difficult to separate.

For this reason, even if being pulverized by the coal pulverizing apparatus of the related art, the coarse particles and fine powder of the pulverized biomass powder are solidified and become difficult to move. As a result, there are problems in that excessive pulverization occurs, the pulverization processing amount of the biomass feedstock declines significantly compared to the case of coal pulverization, and the consumption power in the pulverizing apparatus increases.

Moreover, even in a case where mixed pulverization is performed with coal, if a mixed pulverization rate is generally raised with 5 to 10% up to a mixing limit of the woody biomass feedstock, there are problems in that the particle size of the fine powder declines and the combustion efficiency in the burner deteriorates.

Further, since the power of the pulverizing apparatus increases, it is necessary to lower the capacity of the pulverizing apparatus to perform operation.

2) Further, in order to perform floating combustion of the woody biomass feedstock using the coal burning boiler of the related art, it is necessary to perform pulverization such that an average particle diameter is about 0.5 to 1 mm. However, there is a problem in that, for example, pulverizing a large amount to this size, using a hammer mill or a cutter mill, is inefficient.

3) Moreover, since the woody biomass powder (coarse particles) that is not sufficiently pulverized have an irregular shape, and is apt to be entangled with each other, even if the woody biomass powder is discharged from the outer peripheral portions of the pulverizing rollers, and rises due to a jet air current provided around the pulverizing table, there are problems in that separation of the coarse particles and the fine powder is not easy, and a ratio in which pulverization is performed to exceed a particle diameter required for burning-out increases, and pulverization power increases.

Thus, unlike the pulverizing apparatus that uses the coal pulverizing apparatus of the related art, the appearance of a biomass pulverizing apparatus that can pulverize the woody biomass feedstock efficiently and stably is desired.

An object of the invention is to provide a biomass pulverizing apparatus and a biomass/coal mixed-combustion system that can pulverize biomass feedstock efficiently and stably in view of the above problems.

### Solution to Problem

According to a first aspect of the present inventions in order to solve the above problems, there is provided a biomass pulverizing apparatus including: a pulverizing apparatus body having a feedstock supply pipe for supplying biomass feedstock from above in a vertical axial direction; a pulverizing table for placing the supplied biomass feedstock thereon; a drive section for rotationally driving the pulverizing table; a pulverizing roller for pulverizing the biomass feedstock by a pressing force, the pulverizing roller being operated in conjunction with the rotation of the pulverizing table; and a blower unit for forming an upward flow upward from below on the outer peripheral side of the pulverizing table so as to jet conveying gas for conveying the pulverized biomass powder in an air stream, wherein an erected weir is provided around the pulverizing table, and a first extending weir extends from the pulverizing apparatus body side at lower portions of the pulverizing rollers and is formed with a plurality of slits that forms a predetermined gap with the upper surface of the erected weir.

According to a second aspect of the present inventions, there is provided the biomass pulverizing apparatus according to the first aspect, further including: a second extending weir that is provided to extend to a roller bottom side on a wake flow side in the rotational direction of the pulverizing rollers from the first extending weir and is formed with a plurality of slits that form a predetermined gap from the upper surface of the pulverizing table.

According to a third aspect of the present inventions, there is provided the biomass pulverizing apparatus according to the first or second aspect, wherein the shape of small-diameter end portions of the pulverizing rollers on the central side of the pulverizing table is made into a tapered shape.

According to a fourth aspect of the present inventions, there is provided a biomass/coal mixed-combustion system including: the biomass pulverizing apparatus according to any one of the first to third aspects; a coal pulverizing apparatus for pulverizing coal feedstock; and a boiler furnace to which biomass powder pulverized by the biomass pulverizing apparatus and coal powder pulverized by the coal pulverizing apparatus are supplied.

### Advantageous Effects of Invention

According to the invention, the biomass feedstock can be additionally pulverized to a predetermined particle diameter due to a shearing action when passing between the slits by installing the first extending weir with a plurality of slits.

### BRIEF DESCRIPTION OF DRAWINGS

FIG. 1 is a schematic view of a biomass pulverizing apparatus according to a first embodiment.

FIG. 2 is a cross-sectional schematic view of the biomass pulverizing apparatus according to the first embodiment.

FIG. 3 is a schematic view of a pulverizing table and pulverizing rollers according to the first embodiment.

FIG. 4 is a schematic view of a pulverizing table and pulverizing rollers according to a second embodiment.

FIG. 5 is a schematic view of a biomass/coal mixed-combustion system including a boiler furnace according to a third embodiment.

### DESCRIPTION OF EMBODIMENTS

The invention will be described below in detail while referring to the drawings. Note that, the invention is not limited by the embodiments. Further, constituent elements in the following embodiments include elements that are easily conceivable by a person skilled in the art, or substantially the same elements.

### First Embodiment

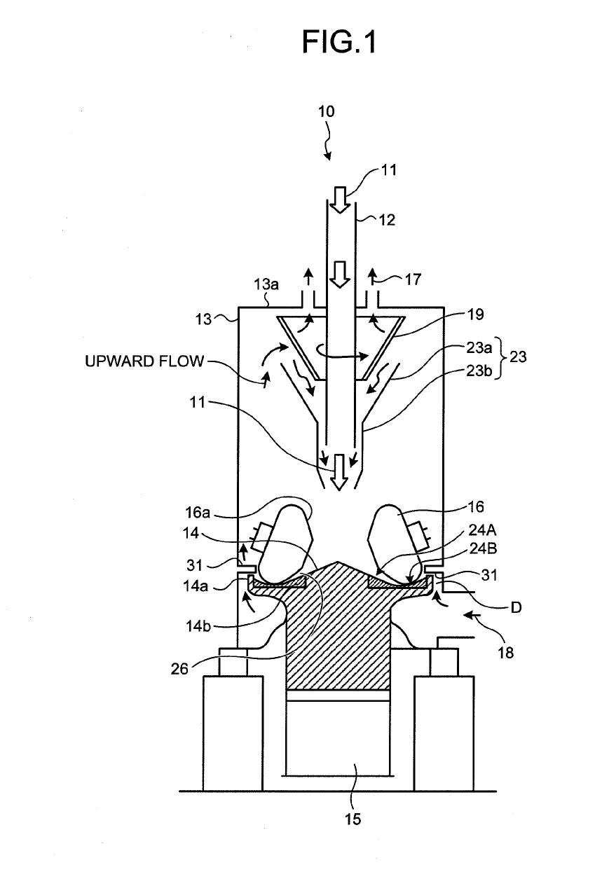

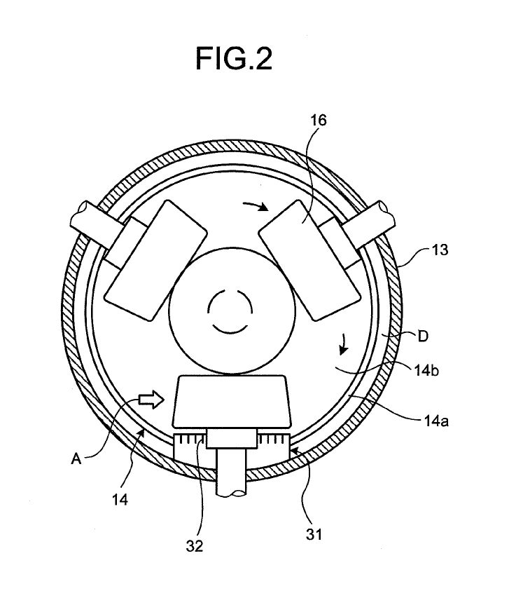

A biomass pulverizing apparatus according to a first embodiment of the invention will be described with reference to the drawings. FIG. 1 is a schematic view of the biomass pulverizing apparatus according to the present embodiment. FIG. 2 is a cross-sectional schematic view of the biomass pulverizing apparatus according to the first embodiment.

As illustrated in FIGS. 1 and 2, a biomass pulverizing apparatus 10 according to the present embodiment includes a pulverizing apparatus body 13 having a feedstock supply pipe 12 that supplies biomass feedstock 11 from above in a vertical axial direction, a pulverizing table 14 on which the supplied biomass feedstock 11 is placed, a drive section 15 that rotationally drives the pulverizing table 14, pulverizing rollers 16 that are operated in conjunction with the rotation of the pulverizing table 14 and pulverize the biomass feedstock 11 by a pressing force, and blower means (not illustrated) that forms an upward flow upward from below on the outer peripheral side of the pulverizing table 14 and jets conveying gas 18 that conveys the pulverized biomass powder 17 in an air stream, and the pulverizing apparatus further includes an erected weir 14a that is provided around the pulverizing table 14, and a first extending weir 31 that extends from the pulverizing apparatus body 13 side at lower portions of the pulverizing rollers 16 and is formed with a plurality of slits 32 that form a predetermined gap 33 with the upper surface of the erected weir 14a.

The pulverizing table 14 is formed in a substantially circular trapezoidal shape, the upper surface of the pulverizing table 14 is formed in a concave shape so that the biomass solid matter placed on this table does not fall off, and a weir 14a is on the outer peripheral side of the upper surface. Further, a freely replaceable table liner 14b is provided in order to prevent wear of the pulverizing table 14.

Note that, a motor (not illustrated) is connected to a drive shaft (not illustrated) that is provided to extend from the lower side of the pulverizing table 14, and the pulverizing table 14 is rotated by the motor.

The pulverizing rollers 16 are provided above a position shifted outward from the center of the pulverizing table 14. The pulverizing rollers 16 exert a pressing force on the biomass feedstock 11 placed on the table liner 14b of the pulverizing table 14 while rotating in conjunction with the pulverizing table 14, and pulverize this biomass feedstock.

At this time, a speed reducer is connected to the motor, and a variable hydraulic power source or a spring that changes pulverization load is connected to the pulverizing rollers 16. A control can be performed by a control device (not illustrated) so that the pulverization load of the pulverizing rollers 16 is increased and decreased in a stepless fashion or in a stepwise fashion and pulverization power falls within a rated range.

The feedstock supply pipe 12 is inserted through a top plate 13a of the pulverizing apparatus body 13 in the vertical axial direction, and is installed so that the biomass feedstock 11 is dropped onto the pulverizing table 14.

The classifier 19 carries out secondary classification of a slightly fine powder and granular material after being passed through pneumatic classification (primary classification) by conveying gas (primary air) 18, and a fixed classifier (cyclone separator), a rotary classifier (rotary separator) or the like is used. In the present embodiment, a combination of the rotary classifier 19 and the funnel-shaped rectifying member (coarse powder recovery machine) 23 is constructed, and the coarse particles and the fine particle are classified by the rotary classifier. The classified coarse particles fall to the pulverizing table 14 side via the funnel-shaped rectifying member and are pulverized again.

The blower unit that supplies the conveying gas (primary air) 18 supplies primary air with a predetermined flow rate and a predetermined temperature into the apparatus body 13 from the periphery of the pulverizing table 14, and a damper or the like is used for adjustment of an air flow rate. Further, temperature control unit is provided if needed. The air flow rate or temperature is appropriately controlled by the control device (not illustrated).

A gap D is provided between the outer peripheral edge of the pulverizing table 14 and the inner peripheral surface of the apparatus body 13, and the conveying gas (primary air) 18 supplied from the blower unit blows to the upper side of the pulverizing table 14 via the gap D. Note that, drift vanes (not illustrated) may be provided in the gap D. The drift vanes adjust the direction of the blowdown of the primary air, and the angle of the drift vanes may be preferably controlled arbitrarily.

A funnel-shaped rectifying member 23 with the same shape as the classifier 19 is fixed at a predetermined interval from the classifier 19 on the side of an upper portion of the apparatus body 13 and is provided to extend downward. The funnel-shaped rectifying member 23 drops the biomass powder (coarse particles) classified by the classifier 19 to the pulverizing table 14 again. The funnel-shaped rectifying member 23 is formed from a funnel portion 23a that receives the classified biomass powder (coarse particles) that is expanded and contracted from an upper portion of the rectifying member toward a lower portion thereof, and a tubular portion 23b that has a predetermined interval from the feedstock supply pipe 12 and drops the biomass powder (coarse particles).

Note that, a lower end portion of the tubular portion 23b of the funnel-shaped rectifying member 23 is reduced in diameter and prevents diffusion of the biomass powder (coarse particles) that is classified and falls.

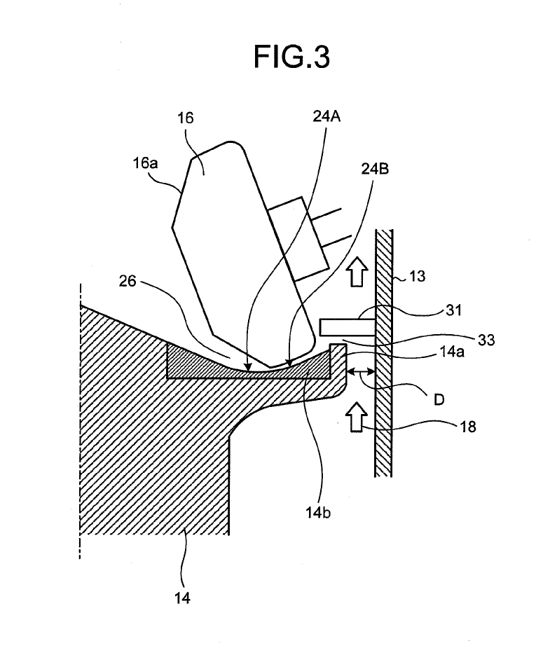

FIG. 3 is a schematic view of the pulverizing table and the pulverizing rollers according to the first embodiment when viewed in the direction of arrow A of FIG. 2.

In the present embodiment, as illustrated in FIG. 3, the shape of the pulverizing rollers 16 is made into a tapered shape by chamfering (16a) the small-diameter end portions on the central side of the pulverizing table 14. As a result, a larger gap 26 compared to the related art is formed between the pulverizing rollers 16 and the pulverizing table 14, and a coarse particles pulverization region 24A on the center side and a fine pulverization region 24B on the outer peripheral side are formed.

Woody chips whose top size is about 25 mm, and woody biomass of the coarse particles (about 3 to 10 mm) that are classified by the classifier 19 and are dropped and recycled are intermingled on the central side of the pulverizing table 14.

Since the biomass having such a coarse particle diameter is not suitable for compression pulverization using the pulverizing rollers 16 and the pulverizing table 14, it is necessary to finely cut the biomass to an intermediate size by a shearing action.

For this reason, small-diameter end portions on the central side of the pulverizing table 14 are chamfered (16a) into a tapered shape so as to make the circumferential speed difference between the pulverizing table 14 and the pulverizing rollers 16 maximum on the inner peripheral portion side, and a shearing force is provided to the biomass feedstock 11 so as to divide the texture of the woody biomass.

That is, since the speed on the small-diameter side of the pulverizing rollers 16 becomes extremely slow and becomes different from the speed of the pulverizing table 14 side by chamfering (16a) the small-diameter end portion into a tapered shape, the shearing force can be increased.

Further, in the present embodiment, as illustrated in FIG. 3, the pulverizing apparatus further includes the erected weir 14a that is provided around the pulverizing table 14, and the first extending weir 31 that extends from the pulverizing apparatus body 13 side at lower portions of the pulverizing rollers 16 and is formed with a plurality of slits that form the predetermined gap 33 with the upper surface of the erected weir 14a.

If the biomass feedstock 11 is supplied to the pulverizing table 14 and pulverized by the pulverizing rollers 16, on the outer peripheral side of the pulverizing table 14, the biomass feedstock 11 that has been pulverized and consolidated to some extent moves upward from the back faces of the pulverizing rollers 16 and in the circumferential direction from the lower faces of the pulverizing rollers 16. In this case, the biomass feedstock is pulverized to a predetermined particle diameter due to a shearing action when passing through between the plurality of slits 32 by installing the first extending weir 31 with the plurality of slits 32 according to a required particle diameter.

Note that, in order to avoid excessive pulverization of the feedstock, it is desirable to make the load imposed on the pulverizing rollers 16 smaller than a coal pulverizing mill of the related art and to secure layer thickness.

As a result, by providing the first extending weir 31 having the plurality of slits 32, an additional shearing action is generated in the pulverization between the pulverizing rollers 16 and the table liner 14b, and this contributes to improvements in pulverization efficiency.

When the biomass feedstock 11 is pulverized using the pulverizing rollers 16, shearing pulverization is additionally performed in addition to the original pulverization between the pulverizing rollers 16 and the table liner 14b by utilizing movement of the pulverized biomass matter from the roller back faces accompanied with the rotation of the pulverizing table 14 and installing the first extending weir 31 having the slits 32 at predetermined intervals. Thereby, overall pulverization efficiency can be improved.

### Second Embodiment

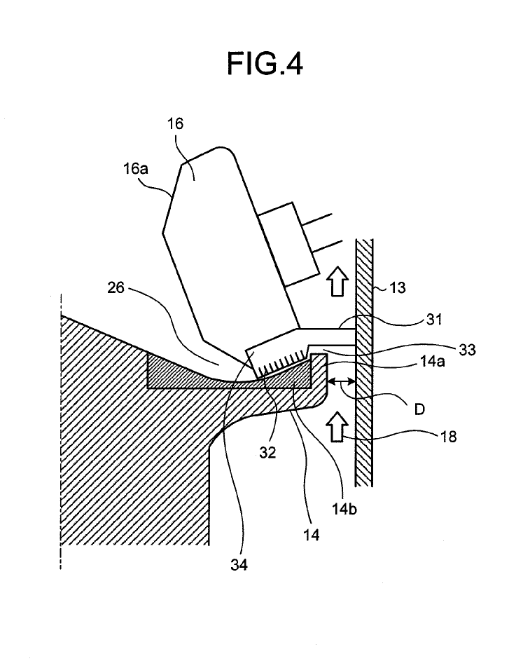

A biomass pulverizing apparatus according to a second embodiment of the invention will be described with reference to the drawing. FIG. 4 is a schematic view of a pulverizing table and pulverizing rollers according to the second embodiment. Note that, the same members as the components of the biomass pulverizing apparatus according to the first embodiment will be designated by the same reference numerals, and the description thereof will not be repeated.

As illustrated in FIG. 4, the biomass pulverizing apparatus according to the present embodiment further includes a second extending weir 34 that is provided to extend to a roller bottom side on a wake flow side in the rotational direction of the pulverizing rollers 16 from the first extending weir 31 and is formed with a plurality of slits 32 that forms a predetermined gap from the upper surface of the pulverizing table 14, in the biomass pulverizing apparatus according to the first embodiment.

On the outer peripheral side of the pulverizing table 14, the feedstock that has been pulverized and consolidated to some extent moves upward from the back faces of the pulverizing rollers 16 and in the circumferential direction from the lower faces of the pulverizing rollers 16. However, the feedstock is pulverized to a predetermined particle diameter due to a shearing action when passing through between the slits 32 by installing the first extending weir 31 and the second extending weir 34 with the slits 32 according to a desired particle diameter.

In order to avoid excessive pulverization of the feedstock, it is desirable to make the load imposed on the pulverizing rollers 16 smaller than in a coal pulverizing mill of the related art and to secure layer thickness.

As a result, by providing the first extending weir 31 and the second extending weir 34 having the slits 32, an additional shearing action is generated in the pulverization between the pulverizing rollers 16 and the table liner 14b, and contributes to improvement in pulverization efficiency.

### Third Embodiment

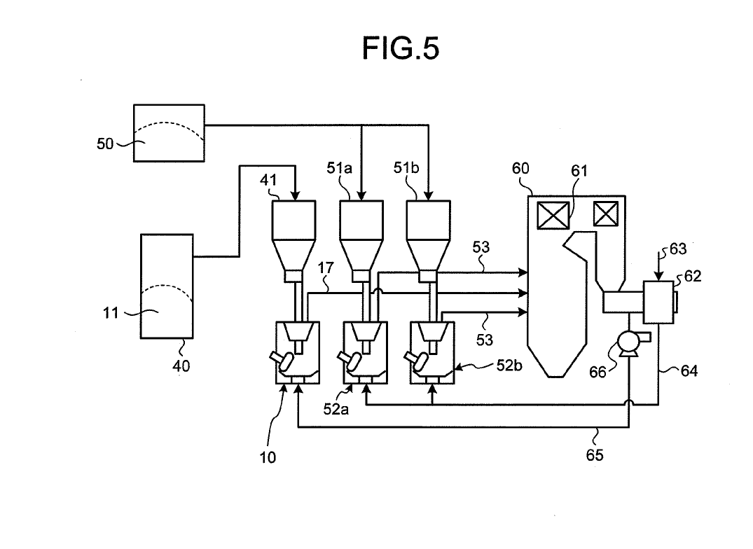

A biomass/coal mixed-combustion system including a boiler furnace according to a third embodiment of the invention will be described with reference to the drawing. FIG. 5 is a schematic view of a biomass/coal mixed-combustion system including a boiler furnace according to the present embodiment.

As illustrated in FIG. 5, the above-described biomass pulverizing apparatus 10 is applied to the biomass/coal mixed-combustion system including a boiler furnace according to the present embodiment.

As illustrated in FIG. 5, the biomass/coal mixed-combustion system according to the present embodiment includes a biomass storage facility 40 in which the biomass feedstock 11 that is primarily pulverized (coarsely crushed) and dried to a predetermined particle diameter or less, if necessary, is stored, the biomass pulverizing apparatus 10 including a biomass hopper 41 to which the biomass feedstock 11 is supplied, coal pulverizing apparatuses 52a and 52b including hoppers 51a and 51b that receive coal 50, and a boiler furnace 60 to which the biomass powder 17 obtained by the biomass pulverizing apparatus 10 and the coal powder 53 obtained by the coal pulverizing apparatuses 52a and 52b are supplied. The biomass feedstock 11, such as wood waste, is sorted into certain degrees of size, stored in the biomass storage facility 40 as biomass chips, and then supplied to the biomass hopper 41. The biomass chips are supplied to the biomass pulverizing apparatus 10 from the biomass hopper 41 and are pulverized by the pulverizing table 14 and the pulverizing rollers 16. Pulverized biomass matter and pulverized coal matter after pulverization are supplied to the boiler furnace 60, and biomass powder and coal powder are mixed and combusted within the boiler furnace 60.

A fuel supply nozzle and a burner that operates with this nozzle are disposed in a furnace body of the boiler furnace 60. The combustion exhaust gas generated by combustion heats a heat exchanger tube 61 disposed within the furnace, and is sent to a flue. An air heater (AH) 62 is provided in the middle of the flue provided in a furnace outlet of the furnace body, and the combustion exhaust gas that has passed through the air heater 62 is discharged to the atmosphere through an exhaust gas treatment facility (not illustrated), such as an ash trapping device.

High-temperature air 64 generated by heated ambient air 63 using the air heater 62 is supplied to the coal pulverizing apparatuses 52a and 52b and is used for drying of coal. Further, a portion of a combustion exhaust gas 65 is supplied to the biomass pulverizing apparatus 10 by an induction fan 66 and is used for classification or drying of the biomass.

By providing the system including the biomass pulverizing apparatus according to the invention in this way, biomass pulverization becomes good. Thus, stable combustion is possible without lowering combustion performance when pulverized matter is directly introduced into a combustion device.

Further, since the total amount of the blowing gas does not change compared to the related art, it is possible to stably operate the biomass pulverizing apparatus within a range of the amount of air required for a combustion facility without a change in the primary air.

### REFERENCE SIGNS LIST

10 Biomass pulverizing apparatus
11 Biomass feedstock
12 Feedstock supply pipe
13 Pulverizing apparatus body
14 Pulverizing table
15 Drive section
16 Pulverizing roller
17 Biomass powder
18 Conveying gas
19 Classifier
31 First extending weir
32 Slit
33 Gap
34 Second extending weir

1. A biomass pulverizing apparatus comprising:
a pulverizing apparatus body having a feedstock supply pipe for supplying biomass feedstock from above in a vertical axial direction;
a pulverizing table for placing the supplied biomass feedstock thereon;
a drive section for rotationally driving the pulverizing table;
a pulverizing roller for pulverizing the biomass feedstock by a pressing force, the pulverizing roller being operated in conjunction with the rotation of the pulverizing table; and
a blower unit for forming an upward flow upward from below on the outer peripheral side of the pulverizing table so as to jet conveying gas for conveying the pulverized biomass powder in an air stream, wherein
an erected weir is provided around the pulverizing table,
a first extending weir extends from the pulverizing apparatus body side at lower portions of the pulverizing rollers and is formed with a plurality of slits that forms a predetermined gap with the upper surface of the erected weir, and
the biomass pulverizing apparatus further comprises a second extending weir that is provided to extend to a roller bottom side on a wake flow side in the rotational direction of the pulverizing rollers from the first extending weir and is formed with a plurality of slits that form a predetermined gap from the upper surface of the pulverizing table.

2. (canceled)

3. The biomass pulverizing apparatus according to claim 1,
wherein the shape of small-diameter end portions of the pulverizing rollers on the central side of the pulverizing table is made into a tapered shape.

4. A biomass/coal mixed-combustion system comprising:
the biomass pulverizing apparatus according to claim 1;
a coal pulverizing apparatus for pulverizing coal feedstock; and
a boiler furnace to which biomass powder pulverized by the biomass pulverizing apparatus and coal powder pulverized by the coal pulverizing apparatus are supplied.
